(19) United States
(12) Patent Application Publication
(10) Pub. No.: US 2011/0050957 A1
(43) Pub. Date: Mar. 3, 2011

(54) IMAGE CAPTURING DEVICE AND QUICK TURN-ON METHOD THEREOF

(75) Inventor: CING-SHIN LIN, Tu-Cheng (TW)

(73) Assignee: HON HAI PRECISION INDUSTRY CO., LTD., Tu-Cheng (TW)

(21) Appl. No.: 12/688,844

(22) Filed: Jan. 15, 2010

(30) Foreign Application Priority Data
Aug. 28, 2009 (CN) 200910306297.3

(51) Int. Cl. H04N 5/76; H04N 5/225

(52) U.S. Cl. 348/231.7; 348/231.99; 348/372; 348/E05.031; 348/E05.024

(57) ABSTRACT

An image capturing device includes a main memory, an auxiliary memory, an image capturing module, a quick turn-on button, a first initialization module, and a second initialization module. The capacity of the auxiliary memory is smaller than that of the main memory and is capable of storing images after being initialized. The image capturing module is capable of capturing images after being initialized. The quick turn-on button is configured for starting the image capturing device. The first initialization module is configured for initializing the image capturing module and the auxiliary memory when the quick turn-on button is triggered. The second initialization module is configured for initializing the main memory after the image capturing module and the auxiliary memory being initialized.

### BACKGROUND

1. Technical Field

The present disclosure relates to image capturing devices and, particularly, to an image capturing device and a quick turn-on method thereof.

2. Description of Related Art

With the development of electro-optical imaging technology, image capturing devices are widely used now. Typically, when we want to capture an image, we need turn on the image capturing device first, the image capturing device will initialize various components thereof, such as image capturing module, main memory etc, before the image capturing device is ready to capture an image. However, because there are so many components needing to be initialized when turning on the image capturing device, the whole process takes up a long time, as a result, an important image capturing opportunity may be missed.

What is needed, therefore, is an image capturing device and a quick turn-on method thereof to overcome or at least mitigate the above-described problem.

### BRIEF DESCRIPTION OF THE DRAWINGS

Many aspects of the present image capturing device and quick turn-on method thereof can be better understood with reference to the accompanying drawings. The components in the drawings are not necessarily drawn to scale, the emphasis instead being placed upon clearly illustrating the principle of the present image capturing device and quick turn-on method thereof. In the drawings, all the views are schematic.

FIG. 1 is a schematic, functional block diagram of an image capturing device according to an exemplary embodiment.

FIG. 2 is a flowchart of a quick turn-on method of the image capturing device of FIG. 1 according to an exemplary embodiment.

### DETAILED DESCRIPTION

Embodiments of the present disclosure will now be described in detail below, with reference to the accompanying drawings.

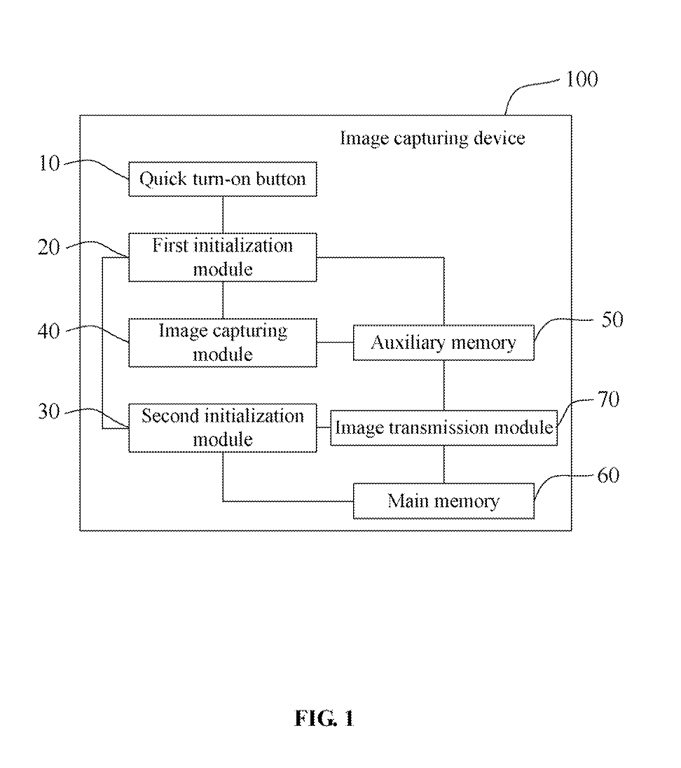

Referring to FIG. 1, an image capturing device 100 according to an exemplary embodiment, is shown. The image capturing device 100 includes a quick turn-on button 10, a first initialization module 20, a second initialization module 30, an image capturing module 40, an auxiliary memory 50, a main memory 60, and an image transmission module 70. The image capturing device 100 can be a digital still camera, a video camera, a mobile phone etc.

When a user is in a hurry rather than turning on the device 100 by some standard way, the user instead activates the quick turn-on button 10 to quickly start the image capturing device 100. The quick turn-on button 10 can be disposed on a casing (not shown) of the image capturing device 100.

The first initialization module 20 is configured for initializing the image capturing module 40 and the auxiliary memory 50 when the quick turn-on button 10 is triggered by being, for example, pressed.

The image capturing module 40 can be used for capturing images after being initialized by the first initialization module 20. The image capturing module 40 can be controlled by a shutter button (not shown) to capture images. In the present embodiment, in order that the image capturing device 100 can capture images as soon as possible after the quick turn-on button 10 is triggered, the image capturing module 40 will capture a predetermined number of images automatically after being initialized by the first initialization module 20 when the quick turn-on button 10 is used.

The auxiliary memory 50 is used for storing the images captured by the image capturing module 40 after the image capturing device 100 is started by the quick turn-on button 10. The capacity of the auxiliary memory 50 is much smaller than that of the main memory 60, thus, the time for initializing the auxiliary memory 50 can be much shorter than the time for initializing the main memory 60. The auxiliary memory 50 can be a random access memory.

The second initialization module 30 is configured for initializing the main memory 60 and the image transmission module 70 after the image capturing module 40 and the auxiliary memory 50 are initialized by the first initialization module 20.

The image transmission module 70 is configured for transmitting images from the auxiliary memory 50 to the main memory 60 after the main memory 60 is initialized. The main memory 60 can be a memory card.

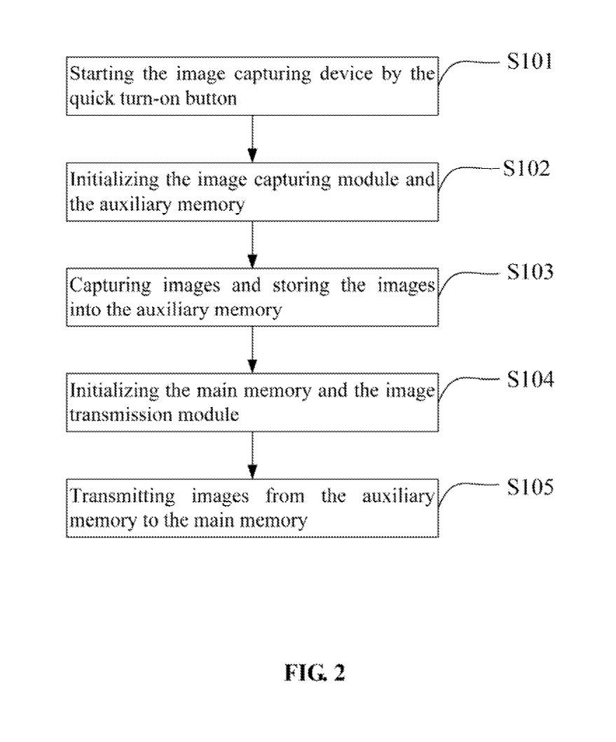

Referring to FIG. 2, a quick turn-on method of the image capturing device 100 of FIG. 1 is also provided. The method includes the following steps.

Step S101: starting the image capturing device 100 by the quick turn-on button 10.

Step S102: initializing the image capturing module 40 and the auxiliary memory 50. In the present embodiment, the first initialization module 20 is configured for initializing the image capturing module 40 and the auxiliary memory 50.

Step S103: capturing images and storing the images into the auxiliary memory 50.

Step S104: initializing the main memory 60 and the image transmission module 70. In the present embodiment, the second initialization module 30 is configured for initializing the main memory 60 and the image transmission module 70.

Step S105: transmitting images from the auxiliary memory 50 to the main memory 60. In the present embodiment, the image transmission module 70 is configured for transmitting images from the auxiliary memory 50 to the main memory 60.

In the present embodiment, the image capturing device 100 initializing the image capturing module 40 and the auxiliary memory 50 first, therefore, the image capturing device 100 can capture images as soon as possible after the quick turn-on button 10 being triggered.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. An image capturing device comprising:
a main memory;
an auxiliary memory with smaller capacity than that of the main memory and capable of storing images after being initialized;
an image capturing module capable of capturing images after being initialized;
a quick turn-on button for starting the image capturing device;
a first initialization module configured for initializing the image capturing module and the auxiliary memory when the quick turn-on button is triggered; and
a second initialization module configured for initializing the main memory after the image capturing module and the auxiliary memory being initialized.

2. The image capturing device of claim 1, further comprising an image transmission module for transmitting images from the auxiliary memory to the main memory after the main memory being initialized, the image transmission module being initialized by the second initialization module after the image capturing module and the auxiliary memory being initialized.

3. The image capturing device of claim 1, wherein the image capturing device is a digital still camera, a video camera, or a mobile phone with an image capturing function.

4. The image capturing device of claim 1, wherein the image capturing module captures a predetermined number of images automatically after being initialized by the first initialization module when the quick turn-on button is triggered.

5. The image capturing device of claim 1, wherein the auxiliary memory is a random access memory.

6. The image capturing device of claim 1, wherein the main memory is a memory card.

7. A quick turn-on method of an image capturing device, the image capturing device comprising a main memory, an auxiliary memory which capacity being smaller than that of the main memory, an image capturing module capable of capturing images after being initialized, and quick turn-on button for starting the image capturing device, the method comprising the steps of:
starting the image capturing device by the quick turn-on button;
initializing the image capturing module and the auxiliary memory;
capturing images and storing the images into the auxiliary memory; and
initializing the main memory after the image capturing module and the auxiliary memory being initialized.

8. The method of claim 7, further comprising the step of: transmitting images from the auxiliary memory to the main memory after the main memory is initialized.

9. The method of claim 7, wherein the image capturing device is a digital still camera, a video camera, or a mobile phone.

10. The method of claim 7, wherein the step of capturing images and storing the images into the auxiliary memory, is executed automatically after the step of initializing the image capturing module and the auxiliary memory.

11. The method of claim 7, wherein the auxiliary memory is a random access memory.

12. The method of claim 7, wherein the main memory is a memory card.
